(19) United States
(12) Patent Application Publication
(10) Pub. No.: US 2022/0288721 A1
(43) Pub. Date: Sep. 15, 2022

(54) METHOD AND APPARATUS FOR CLEANING GRAPHITE-BASED SAMPLE

(71) Applicant: FOOTEK CO., LTD., Tongluo Township (TW)

(72) Inventor: Chun-Hung LIN, Tongluo Township (TW)

(21) Appl. No.: 17/687,418

(22) Filed: Mar. 4, 2022

(30) Foreign Application Priority Data
Mar. 9, 2021 (TW) 110108356

(51) Int. Cl. B23K 26/36; B23K 26/082; B23K 26/0622; B23K 26/06; B23K 26/18

(52) U.S. Cl. CPC B23K 26/36; B23K 26/082; B23K 26/0622; B23K 26/0648; B23K 26/18; B23K 26/0643

(57) ABSTRACT

A method for cleaning a graphite-based sample includes (A) providing a graphite-based sample that includes a graphite layer and a non-graphite layer covering the graphite layer; (B) adjusting parameters of a laser beam so that the laser beam has a wavelength ranging from 1000 nm to 1200 nm and a peak power ranging from 0.5 mW to 5 mW; and (C) irradiating the non-graphite layer with the laser beam so that the non-graphite layer absorbs an energy of the laser beam and is removed from the graphite layer. A laser apparatus for cleaning a graphite-based sample is also provided.

### CROSS-REFERENCE TO RELATED APPLICATION

This application claims priority of Taiwanese Invention Patent Application No. 110108356, filed on Mar. 9, 2021.

### FIELD

The disclosure relates to a cleaning method and a cleaning apparatus, and more particularly to a method and an apparatus for cleaning a graphite-based sample.

### BACKGROUND

A grit blasting method is a conventional method for cleaning a graphite-based material. However, the grit blasting method may not only cause the graphite-based material to have a relatively large surface roughness (Ra), but also may cause material loss and damage to the graphite-based material. Further, abrasive particles used in the grit blasting method may remain on the graphite-based material, which would adversely affect the quality of a semiconductor wafer manufactured using the graphite-based material.

Another conventional method for cleaning the graphite-based material is a chemical etching method which uses a chemical reagent to etch and remove impurities from the graphite-based material, followed by use of an acid scavenger to remove the chemical reagent. However, because the graphite-based material has a plurality of pores, the chemical reagent is easily trapped in the pores of the graphite-based material and is unlikely to be removed therefrom, thereby reducing the service life of the graphite-based material. Further, the chemical reagent remaining on the graphite-based material may contaminate the semiconductor wafer.

In addition, the above-mentioned methods would cause air pollution or produce waste, e.g., chemical waste and abrasive particles.

### SUMMARY

Therefore, an object of the disclosure is to provide a method for cleaning a graphite-based sample that can alleviate or eliminate at least one of the drawbacks of the prior art.

According to one aspect of the disclosure, a method for cleaning a graphite-based sample includes:

(A) providing a graphite-based sample that includes a graphite layer and a non-graphite layer covering the graphite layer;

(B) adjusting parameters of a laser beam so that the laser beam has a wavelength ranging from 1000 nm to 1200 nm and a peak power ranging from 0.5 mW to 5 mW; and

(C) irradiating the non-graphite layer with the laser beam so that the non-graphite layer absorbs an energy of the laser beam and is removed from the graphite layer.

Another object of the disclosure is to provide a laser apparatus for cleaning a graphite-based sample.

According to another aspect of this disclosure, a laser apparatus for cleaning a graphite-based sample includes a housing, a laser unit, and a lens unit. The graphite-based sample includes a graphite layer and a non-graphite layer covering the graphite layer. The housing defines a receiving space.

The laser unit is disposed in the receiving space to emit a laser beam that has a wavelength ranging from 1000 nm to 1200 nm and a peak power ranging from 0.5 mW to 5 mW.

The lens unit is disposed in the receiving space, and focuses the laser beam to the non-graphite layer so that the non-graphite layer absorbs an energy of the laser beam and is removed from the graphite layer.

### BRIEF DESCRIPTION OF THE DRAWINGS

Other features and advantages of the disclosure will become apparent in the following detailed description of the embodiment with reference to the accompanying drawings, of which:

FIG. 1 is a flow chart illustrating an embodiment of a method for cleaning a graphite-based sample according to the disclosure;

FIG. 2 is a schematic view illustrating an embodiment of a laser apparatus for cleaning the graphite-based sample according to the disclosure;

FIG. 3 shows images of the graphite-based samples treated by a grit blasting method and the method of the disclosure shown in FIG. 1;

FIG. 4 illustrate measuring positions of the graphite-based sample; and

FIGS. 5 to 8 are images of the graphite-based samples treated by the grit blasting method and the method of the disclosure shown in FIG. 1 which are captured using a scanning electron microscope (SEM) at magnifications of 50×, 2000× and 10,000×.

### DETAILED DESCRIPTION

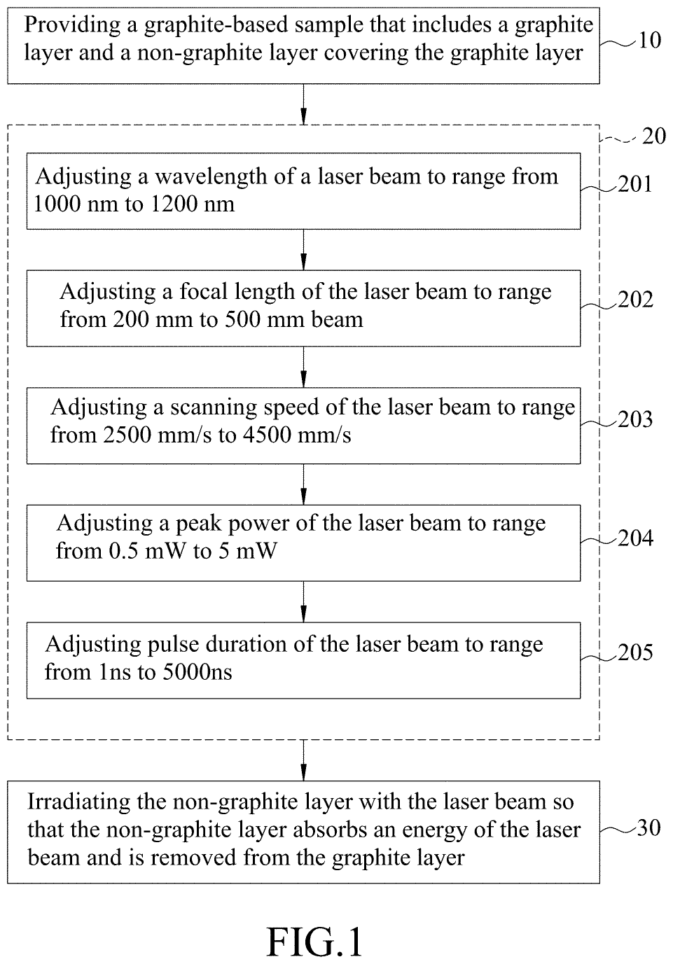

Referring to FIG. 1, an embodiment of a method for cleaning a graphite-based sample according to the disclosure includes the following steps.

In step 10, a graphite-based sample 6 is provided. The graphite-based sample 6 includes a graphite layer 61 and a non-graphite layer 62 covering the graphite layer 61.

In certain embodiments, the non-graphite layer 62 is a coating layer that is formed during sputtering of the graphite layer 61. However, the non-graphite layer 62 may be a residual layer formed during processing of the graphite layer 61.

In step 20, parameters of laser beam are adjusted. The adjustment includes the following sub-steps 201 to 205.

In substep 201, a wavelength of the laser beam is adjusted to range from 1000 nm to 1200 nm.

In substep 202, a focal length of the laser beam is adjusted to range from 200 mm to 500 mm.

In substep 203, a scanning speed of the laser beam is adjusted to range from 2500 mm/s to 4500 mm/s.

In substep 204, a peak power of the laser beam is adjusted to range from 0.5 mW to 5 mW. In substep 205, a pulse duration of the laser beam is adjusted to range from 1 ns to 5000 ns.

In step 30, the non-graphite layer 62 is irradiated with the laser beam so that the non-graphite layer 62 absorbs an energy of the laser beam and is removed from the graphite layer 61.

Removal of the non-graphite layer 62 from the graphite layer 61 may be achieved through interaction between the non-graphite layer and the laser beam with the high density and the short pulse duration. The possible related physical principles are as follows.

(1) Photovaporization/photolysis: The laser beam is focused through an optical system to obtain a high focus energy, which is able to vaporize or decompose the non-graphite layer 62.

(2) Photo-ablation: By irradiating the graphite-base sample 6 with the laser beam, the non-graphite layer 62 of the graphite-based sample 6 is thermally expanded. When an expansion force of the non-graphite layer 62 is greater than a bonding force between the non-graphite layer 62 and the graphite layer 61, the non-graphite layer 62 is detached from the graphite layer 61.

(3) Light vibration: By using a pulsed laser beam having a relatively high frequency and power to impact a surface of the graphite-based sample 6, an ultrasonic wave is generated on the surface of the graphite-based sample 6. The non-graphite layer 62 may slightly burst or crack due to the ultrasonic wave, and is thus removed from the graphite layer 61.

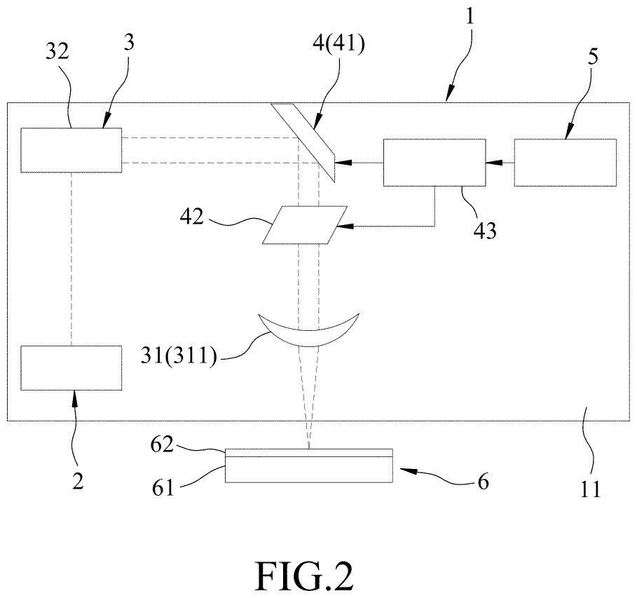

Referring to FIG. 2, an embodiment of a laser apparatus for cleaning a graphite-based sample 6 of the disclosure includes a housing 1, a laser unit 2, a lens unit 3, a light-deflecting unit 4, and a control unit 5.

The housing 1 defines a receiving space 11. The laser unit 2 is disposed in the receiving space 11 to emit a laser beam that has a wavelength ranging from 1000 nm to 1200 nm and a peak power ranging from 0.5 mW to 5 mW. In certain embodiments, the wavelength of the laser beam ranges from 1060 nm to 1070 nm. In this embodiment, the wavelength of the laser beam is 1064 nm.

The laser beam has a beam quality factor (M²) smaller than 2 (M²<2). The laser beam has a single pulse energy ranging from 1 mJ to 100 mJ, and an average power of the laser beam ranges from 20 W to 1000 W.

The lens unit 3 is disposed in the receiving space 11, and includes a lens assembly 31 and a collimating lens 32. The lens assembly 31 includes a plurality of focusing lenses 311 with different focal lengths. Each of the focusing lenses 311 has a focal length ranging from 200 mm to 500 mm. In this embodiment, the lens assembly 31 may include three focusing lenses 311 respectively having focal lengths of 250 mm, 300 mm, and 400 mm. The lens unit 3 focuses the laser beam to the non-graphite layer 62 so that the non-graphite layer 62 absorbs an energy of the laser beam and is removed from the graphite layer 61.

The light-deflecting unit 4 includes a first galvo mirror 41 and a second galvo mirror 42 that are disposed on an optical path of the laser beam between the lens unit 3 and the graphite-based sample 6.

The light-deflecting unit 4 further includes a driving member 43. The first and second galvo mirrors 41, 42 are driven by the driving member 43 to rotate, respectively, about axial lines different from each other.

Noteworthily, based on a thickness of the non-graphite layer 62 of the graphite-based sample 6, a user can select the focusing lenses 311 with the desired focal lengths, and adjust the pulse energy and the scanning speed. In this embodiment, during each cleaning operation, only one of the focusing lenses 311 is located on the optical path of the laser beam, and therefore only one focusing lens 311 is illustrated in FIG. 2.

The control unit 5 is signally connected to the light-deflecting unit 4. The control unit 5 outputs a first signal and a second signal for respectively controlling rotary angles of the first and second galvo mirrors 41, 42 so as to adjust an irradiating position of the laser beam on the non-graphite layer 62.

In this embodiment, the first and second signals of the control unit 5 are transmitted to the driving member 43. According to the first and second signals, the driving member 43 controls the rotary angles of the first and second galvo mirrors 41, 42. In other embodiments of the disclosure, the first and second signals of the control unit 5 can be directly transmitted to the first and second galvo mirrors 41, 42 when each of the first and second galvo mirrors 41, 42 is equipped with a rotating mechanism, thereby controlling the rotary angles of the first and second galvo mirrors 41, 42.

Noteworthily, the laser beam emitted from the laser unit 2 passes through the collimating lens 32, the first and second galvo mirrors 41, 42, and the focusing lens 311, and then is focused on the non-graphite layer 62 of the graphite-based sample 6 to destroy the structure of the non-graphite layer 62, thereby removing the non-graphite layer 62 from the graphite layer 61.

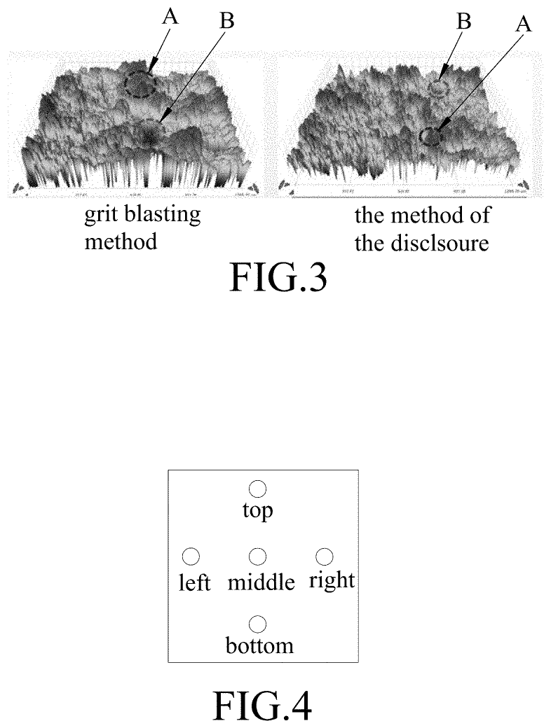

FIG. 3 illustrates images of two graphite-based samples which are respectively subjected to the conventional grit blasting method and the method of the disclosure. As shown in FIG. 3, the letter A refers to a peak (a protruding portion relative to a surface) of the treated graphite-based sample, and the letter B refers to a trough (a concave portion relative to the surface) of the treated graphite-based sample. The colors of the peak and trough of the graphite-based sample treated by the conventional grit blasting method are darker than those of the graphite-based sample treated by the method of the disclosure.

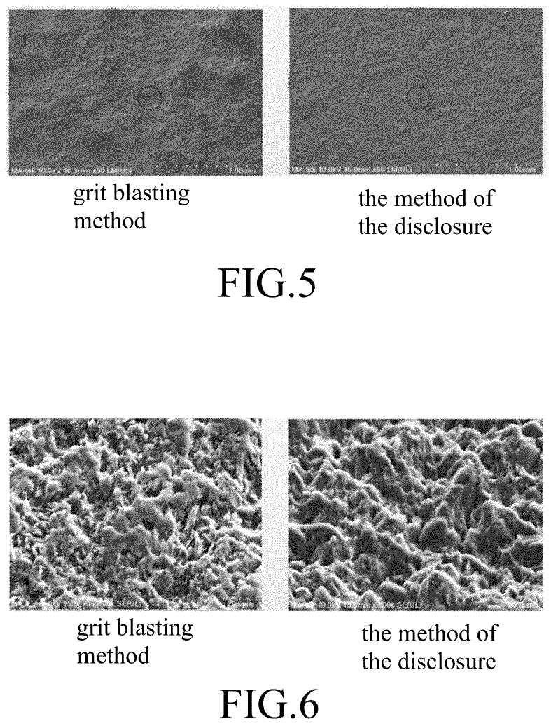

The roughness of the treated graphite-based samples are also measured. FIG. 4 illustrate positions of the treated graphite-based sample for measuring roughness. The average roughness, root mean square roughness, and maximum height between the highest peak and lowest trough (Rt) are measured, and shown in Table 1.

TABLE 1

| | | Root mean | |
|---|---|---|---|
| | Average | square | |
| Method/measuring | roughness | roughness | |
| positions | (μm) | (μm) | Rt (μm) |
| The method of the | 3.92 | 4.88 | 37.55 |
| disclosure/top | | | |
| The method of the | 3.65 | 4.58 | 34.43 |
| disclosure/middle | | | |
| The method of the | 3.41 | 4.33 | 38.31 |
| disclosure/bottom | | | |
| The method of the | 3.37 | 4.24 | 36.77 |
| disclosure/left | | | |
| The method of the | 3.83 | 4.8 | 40.89 |
| disclosure/right | | | |
| Grit blasting | 6.21 | 7.8 | 54.24 |
| method/top | | | |
| Grit blasting | 7.93 | 9.76 | 58.92 |
| method/middle | | | |
| Grit blasting | 8.42 | 11.12 | 84.40 |
| method/bottom | | | |
| Grit blasting | 6.93 | 8.70 | 70.32 |
| method/left | | | |
| Grit blasting | 7.58 | 9.56 | 67.33 |
| method/right | | | |

As shown in Table 1, in comparison with the grit blasting method, the method of the disclosure effectively reduces the average roughness, root mean square roughness and the maximum height between the highest peak and lowest trough (Rt) of the graphite-based samples.

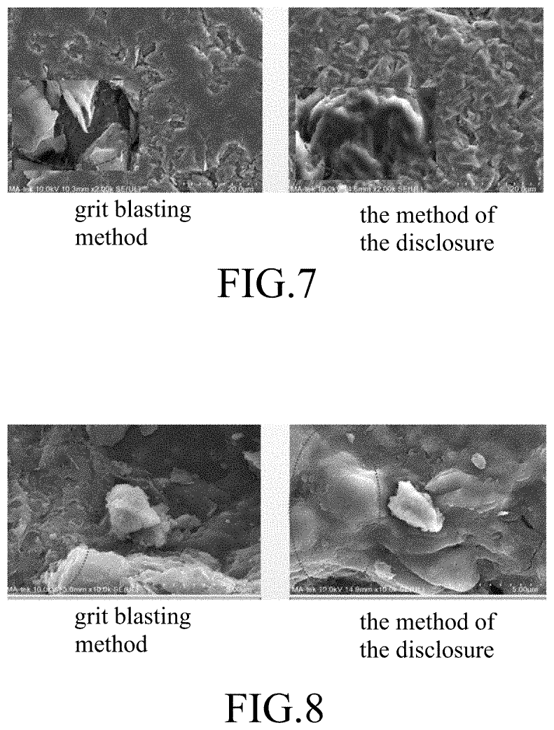

FIGS. 5 to 8 are SEM images of the graphite-based samples which are respectively subjected to the conventional grit blasting method and the method of the disclosure.

FIG. 5 shows images of the graphite-based samples at a magnification of 50×. It is clear that the surface of the graphite-based sample treated by the grit blasting method is more uneven than that of the graphite-based sample treated by the method of this disclosure. Moreover, the depth and diameter of each recess formed on the graphite-based sample treated by the grit blasting method are greater than those of each recess formed by the method of the disclosure, supporting the fact that the surface roughness of the graphite-based sample treated by the grit blasting method is relatively large. Moreover, the height difference between the peaks and troughs of the graphite-based sample treated by the grit blasting method is greater than that of the graphite-based sample treated by the method of the disclosure. These results indicate that the maximum height between the highest peak and lowest trough is effectively reduced in the graphite-based sample treated by the method of the disclosure.

FIGS. 6 and 7 illustrate images of the graphite-based samples at a magnification of 2000×. As shown in these images, the surface structure of the graphite-based sample treated by the grit blasting method is relatively sharp, while the surface structure of the graphite-based sample treated by the method of the disclosure is relatively smooth and round.

FIG. 8 illustrates images of the graphite-based samples at a magnification of 10000×, and shows that the graphite-based sample treated by the grit blasting method has a relatively loose and broken surface structure.

The graphite-based sample 6 subjected to the method of this disclosure, and the graphite-based sample 6′, 6″ subjected to the grit blasting method using different abrasive particles are analyzed using an energy dispersive x-ray spectrometer (EDS). Results in Table 2 show that the graphite-based sample 6 has the highest carbon content. The graphite-based sample 6′ contains aluminum and oxygen due to the abrasive particles being aluminum oxide particles. The graphite-based sample 6″ contains silicon and oxygen, due to the abrasive particles being silicon particles. The results indicate the abrasive particles used in the grit blasting method would remain on the graphite-based sample 6′ and the graphite-based sample 6″, thereby causing secondary contamination when the graphite-based sample 6′ or the graphite-based sample 6″ is reused in the next manufacturing process.

TABLE 2

| Graphite-based | | | Graphite-based | | | Graphite-based | | |
|---|---|---|---|---|---|---|---|---|
| sample 6′ | | | sample 6′ | | | sample 6′ | | |
| Element | | Weight % | Element | | Weight % | Element | | Weight % |
| C | K | 76.01 | C | K | 79.02 | C | K | 94.37 |
| O | K | 11.51 | O | K | 4.61 | O | K | 5.63 |

| | | | | | |
|---|---|---|---|---|---|
| F | K | 3.63 | Si | K | 16.37 |
| Na | K | 0.40 | | | |
| Al | K | 8.45 | | | |

Further, the graphite-based sample 6 treated by the method of the disclosure is detected and analyzed by Inductively Coupled Plasma (ICP) analysis, and the results show that there is no metal remaining on the graphite-based sample 6.

Moreover, the resistance of the graphite-based sample 6 of the disclosure is lower than that of the graphite-based samples 6′, 6″. That is to say, the graphite-based sample 6 of the disclosure has good electrical conductivity. Moreover, the method of this disclosure will not result in material loss of the graphite layer 61.

The method for cleaning a graphite-based sample of this disclosure has the following advantages.

1. By virtue of irradiating the non-graphite layer 62 of the graphite-based sample 6 with the laser beam having the wavelength ranging from 1000 nm to 1200 nm, the non-graphite layer 62 absorbs the energy of the laser beam and is removed from the graphite layer 61 without impairing the graphite layer 61. Compared with the conventional method of using the abrasive particles or chemical reagents, the method of this disclosure produces less amount of air pollutants, particle waste, chemical waste, thereby reducing environmental pollution.

2. When the graphite-based sample 6 cleaned by the method of the disclosure is used for manufacturing semiconductor chips, the yield rate of semiconductor chips may be increased.

3. The graphite-based sample 6 cleaned by the method of this disclosure has a reduced roughness, a relatively smooth surface, and less metal residue.

4. Compared with the conventional grit blasting method, the method of this disclosure can avoid secondary contamination when the graphite-based sample 6 is used in the subsequent chip manufacturing process.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it understood that this disclosure is not limited to the disclosed embodiment but is intended to cover various arrangements included within the spirit and scope of the broadest interpretation so as to encompass all such modifications and equivalent arrangements.

What is claimed is:

1. A method for cleaning a graphite-based sample, comprising:
(A) providing a graphite-based sample that includes a graphite layer and a non-graphite layer covering the graphite layer;
(B) adjusting parameters of a laser beam so that the laser beam has a wavelength ranging from 1000 nm to 1200 nm and a peak power ranging from 0.5 mW to 5 mW; and
(C) irradiating the non-graphite layer with the laser beam so that the non-graphite layer absorbs an energy of the laser beam and is removed from the graphite layer.

2. The method as claimed in claim 1, wherein, in step (B), a focal length of the laser beam is adjusted to range from 200 mm to 500 mm.

3. The method as claim in claim 1, wherein, in step (B), a scanning speed of the laser beam is adjusted to range from 2500 mm/s to 4500 mm/s.

4. The method as claimed in claim 1, wherein, in step (B), a pulse duration of the laser beam is adjusted to range from 1 ns to 5000 ns.

5. A laser apparatus for cleaning a graphite-based sample that includes a graphite layer and a non-graphite layer covering the graphite layer, the laser apparatus comprising:
a housing defining a receiving space;
a laser unit disposed in said receiving space to emit a laser beam that has a wavelength ranging from 1000 nm to 1200 nm and a peak power ranging from 0.5 mW to 5 mW; and
a lens unit disposed in said receiving space, and focusing the laser beam to the non-graphite layer so that the non-graphite layer absorbs an energy of the laser beam and is removed from the graphite layer.

6. The laser-based system as claimed in claim 5, further comprising a light-deflecting unit and a control unit signally connected to said light-deflecting unit, said light-deflecting unit including a first galvo mirror and a second galvo mirror that are disposed on an optical path of the laser beam between said lens unit and the graphite-based sample, said first and second galvo mirrors being rotatable, respectively, about axial lines different from each other, said control unit outputting a first signal and a second signal for respectively controlling rotary angles of said first and second galvo mirrors so as to adjust an irradiating position of the laser beam on the non-graphite layer.

7. The laser-based system as claimed in Claim wherein said lens unit includes a focusing lens having a focal length ranging from 200 mm to 500 mm.

8. The laser-based system as claimed in claim 5, wherein said laser beam has a scanning speed ranging from 2500 mm/s to 4500 mm/s.

9. The laser-based system as claimed in claim 5, wherein said laser beam has a pulse duration ranging from 1 ns to 5000 ns.
